(19) United States
(12) Patent Application Publication
(10) Pub. No.: US 2011/0292348 A1
(43) Pub. Date: Dec. 1, 2011

(54) BALLOON AND BALLOON CONTROL METHOD

(75) Inventors: Hiroaki TOBITA, Tokyo (JP); Shigeaki Maruyama, Kanagawa (JP)

(73) Assignee: Sony Corporation, Tokyo (JP)

(21) Appl. No.: 13/076,946

(22) Filed: Mar. 31, 2011

(30) Foreign Application Priority Data
May 25, 2010 (JP) 2010-119135

(51) Int. Cl. G03B 21/10

(52) U.S. Cl. 353/28; 353/121

(57) ABSTRACT

Provided is a balloon including an envelope and a projecting unit that projects an image, which switches display mode between first display mode that displays the image projected by the projecting unit on the envelope and second display mode that displays the image projected by the projecting unit on an external object through the envelope.

### BACKGROUND OF THE INVENTION

1. Field of the Invention

The present invention relates to a balloon and a balloon control method.

2. Description of the Related Art

A balloon is originally known as an air moving unit that moves in the air with a person or an object riding on it. The balloon is mainly composed of an envelope and a gondola hung beneath the envelope. Buoyancy is obtained by filling the envelope with gas lighter than air in normal condition, and the balloon can float based on the buoyancy.

Recently, use of the balloon for the purpose of entertainment, rather than for a person or an object to ride, has been proposed. For example, a technique that places a LED inside a balloon and makes the LED emit light in synchronization with a sound collected from the outside is disclosed in H. Yoshimoto, K. Jo, K. Hori, Design of Installation with Interactive UAVs, in proceedings of ACM ACE '08, pp. 424, 2008.

### SUMMARY OF THE INVENTION

Further, a new interface with a user may be provided by placing a projector that projects an image toward the envelope inside the balloon. When the envelope is transparent, the image is projected on the outside floor or wall of the balloon, and the balloon can serve as a projecting device that moves in the air. On the other hand, when the envelope is half-transparent, the image is displayed on the surface of the envelop, and the balloon can serve as a display device that moves in the air. However, when the whole envelop is made transparent or half-transparent, the balloon can be used only as either the projecting device or the display device moving in the air.

In light of the foregoing, it is desirable to provide novel and improved balloon and balloon control method that allow use of a single balloon for various applications.

According to an embodiment of the present invention, there is provided a balloon comprising an envelope, and a projecting unit that projects an image, wherein display mode is switched between first display mode that displays the image projected by the projecting unit on the envelope and second display mode that displays the image projected by the projecting unit on an external object through the envelope.

The envelope may include a transparent region and a half-transparent region having lower transparency than the transparent region, and the balloon further includes a control unit that switches the display mode to the first display mode by turning a projecting direction of the image by the projecting unit toward the half-transparent region, and switches the display mode to the second display mode by turning a projecting direction of the image by the projecting unit toward the transparent region.

The balloon may further include a reflector that reflects the image projected by the projecting unit to display the image on the envelope or the external object.

The envelope may include a transparent region and a half-transparent region having lower transparency than the transparent region, and the balloon further includes a control unit that switches the display mode to the first display mode by making the reflector reflect the image projected by the projecting unit toward the half-transparent region, and switches the display mode to the second display mode by making the reflector reflect the image projected by the projecting unit toward the transparent region.

The envelope may include a variable region where transparency varies depending on an applied voltage, and the balloon may further include a control unit that switches the display mode between the first display mode and the second display mode by controlling an applied voltage to the variable region.

The envelope may include a material part where transparency varies depending on an external environment, and the display mode is switched between the first display mode and the second display mode in response to variation of the transparency of the material part depending on the external environment.

The projecting unit may project a face image, and the control unit may make the balloon operate in the first display mode when the face image is projected by the projecting unit.

A mask may be attachable to the envelope in a display position of the face image projected from the projecting unit.

The balloon may further include a sensor that detects a body position, and a power unit that moves the balloon to approach the body position detected by the sensor, wherein the control unit makes the balloon operate in the second display mode when the balloon is moved by the power unit to approach the body position detected by the sensor.

The projecting unit may project a navigation image in an opposite direction to a floating direction of the balloon, and the control unit may make the balloon operate in the second display mode when the navigation image is projected by the projecting unit.

The projecting unit may project a text image, and the control unit may make the balloon operate in the first display mode when the text image is projected by the projecting unit.

The balloon may further include a wireless communication unit that wirelessly communicates with an external device, wherein the control unit controls the display mode according to an instruction received by the wireless communication unit.

The balloon may further include a wireless communication unit that wirelessly communicates with an external device, wherein the projecting unit may project an image received by the wireless communication unit.

The balloon may further include an imaging unit that captures an image, wherein the wireless communication unit may transmit the image captured by the imaging unit to the external device.

The balloon may further include a distance estimation unit that estimates a distance from the external object, wherein the control unit may control zoom of the image projected from the projecting unit depending on the distance estimated by the distance estimation unit when the balloon operates in the second display mode.

According to another embodiment of the present invention, there is provided a balloon control method comprising steps of projecting an image toward an envelope, and switching display mode between first display mode that displays the projected image on the envelope and second display mode that displays the projected image on an external object through the envelope.

According to the embodiments of the present invention described above, it is possible to use a single balloon for various applications.

### BRIEF DESCRIPTION OF THE DRAWINGS

FIG. 1 is an explanatory view showing a structure of a balloon according to a first embodiment of the present invention;

FIG. 2 is an explanatory view showing a balloon operating in first display mode;

FIG. 3 is an explanatory view showing a balloon operating in second display mode;

FIG. 4 is an explanatory view schematically showing a shape of a balloon 20;

FIG. 5 is a functional block diagram showing a structure of a balloon according to the first embodiment;

FIG. 6 is an explanatory view showing a method of switching display mode according to a first method;

FIG. 7 is an explanatory view showing a method of switching display mode according to the first method;

FIG. 8 is an explanatory view showing a specific example of controlling zoom of an image depending on a distance between a balloon and an external object;

FIG. 9 is an explanatory view showing a structure of a balloon for switching display mode according to a second method;

FIG. 10 is an explanatory view showing an application that uses a balloon as an avatar;

FIG. 11 is an explanatory view showing an application that uses a balloon as a navigation device;

FIG. 12 is an explanatory view showing an application that uses a balloon as a speech balloon;

FIG. 13 is a flowchart showing operation of a balloon 20 according to the first embodiment of the present invention;

FIG. 14 is an explanatory view showing a structure of a balloon according to a second embodiment of the present invention; and

FIG. 15 is an explanatory view showing an alternative example of an embodiment of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described hereinafter in the following order.

1. First Embodiment
1-1. Outline of Balloon according to First Embodiment
1-2. Structure of Balloon
1-3. Method of Switching Display Mode
1-4. Application
1-5. Operation of Balloon

2. Second Embodiment

3. Summary

### 1. First Embodiment

### 1-1. Outline of Balloon According to First Embodiment

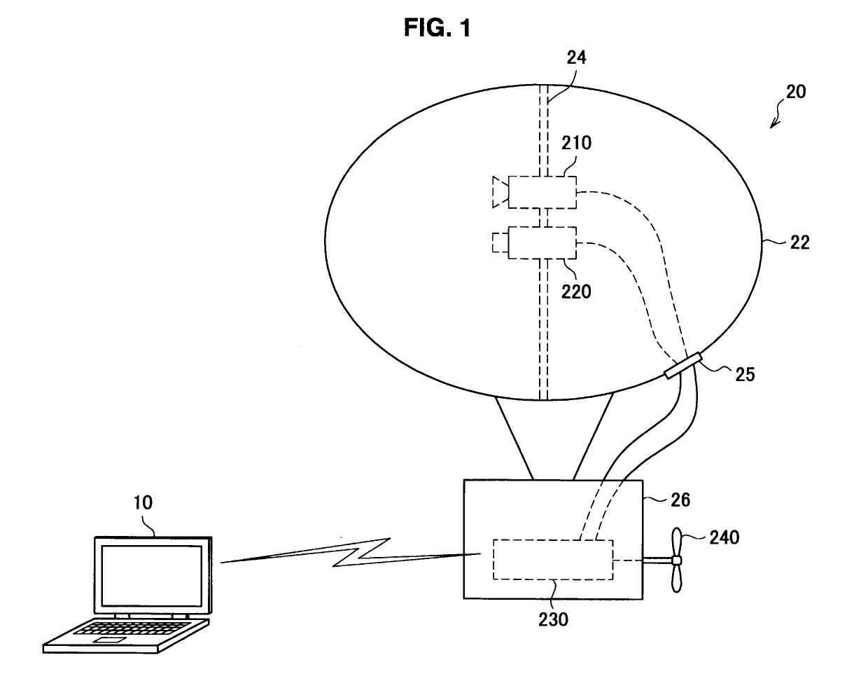

The outline of a balloon according to a first embodiment of the present invention is described hereinafter with reference to FIG. 1.

FIG. 1 is an explanatory view showing a structure of a balloon 20 according to the first embodiment of the invention. Referring to FIG. 1, the balloon 20 according to the first embodiment of the invention includes an envelope 22, a connector 25, and a gondola 26. Further, a stationary member 24, and an imaging unit 210 and a projecting unit 220 coupled to the stationary member 24 are mounted inside the envelope 22. Further, the gondola 26 incorporates a gondola unit 230 and has a power unit 240 mounted outside.

When the envelope 22 is filled with gas lighter than air in normal condition (e.g. helium gas, heated air etc.), the balloon 20 can float based on the buoyancy provided by the gas. Note that the longest part of the envelope 22 may be about 1 m.

Further, the gondola unit 230 wirelessly communicates with an external information processing device 10. For example, the gondola unit 230 receives an operation instruction from the external information processing device 10 and controls the overall operation of the balloon 20 according to the operation instruction. Specifically, when the gondola unit 230 receives an instruction related to movement from the information processing device 10, the gondola unit 230 controls the power unit 240 according to the instruction to move the balloon 20. When the power unit 240 is a propeller, for example, the gondola unit 230 controls the rotational speed, the rotational axis orientation or the like of the propeller.

Although a PC (Persona Computer) is illustrated as an example of the information processing device 10 in FIG. 1, the information processing device 10 is not limited thereto. For example, the information processing device 10 may be a home video processing device (e.g. a DVD recorder, a videocassette recorder etc.), a PDA (Personal Digital Assistants), a home game device, an electrical household appliance, a mobile phone, a portable music playback device, a portable video processing device, a portable game device or the like.

The imaging unit 210, the projecting unit 220 and the gondola unit 230 are connected through the connector 25. Therefore, an image captured by the imaging unit 210 is supplied to the gondola unit 230, and the gondola unit 230 can wirelessly transmit the image to the external information processing device 10.

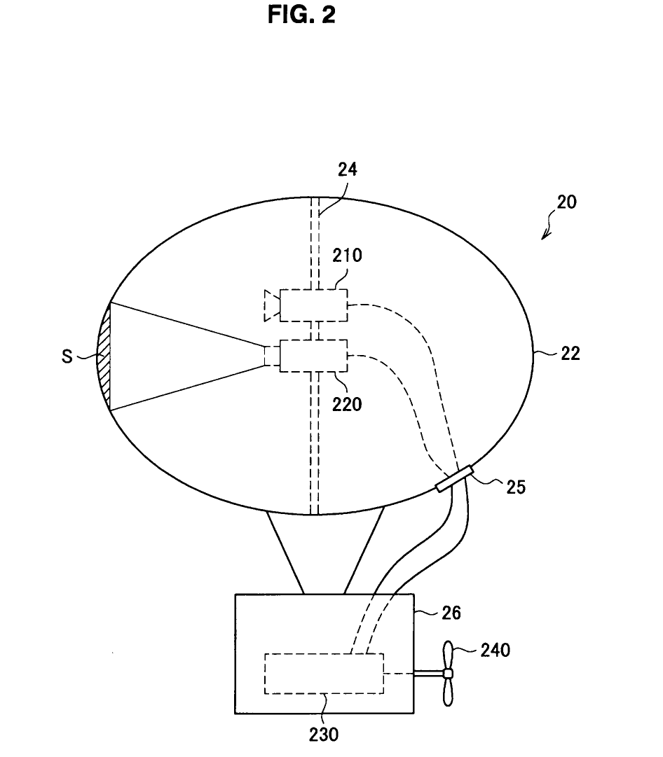

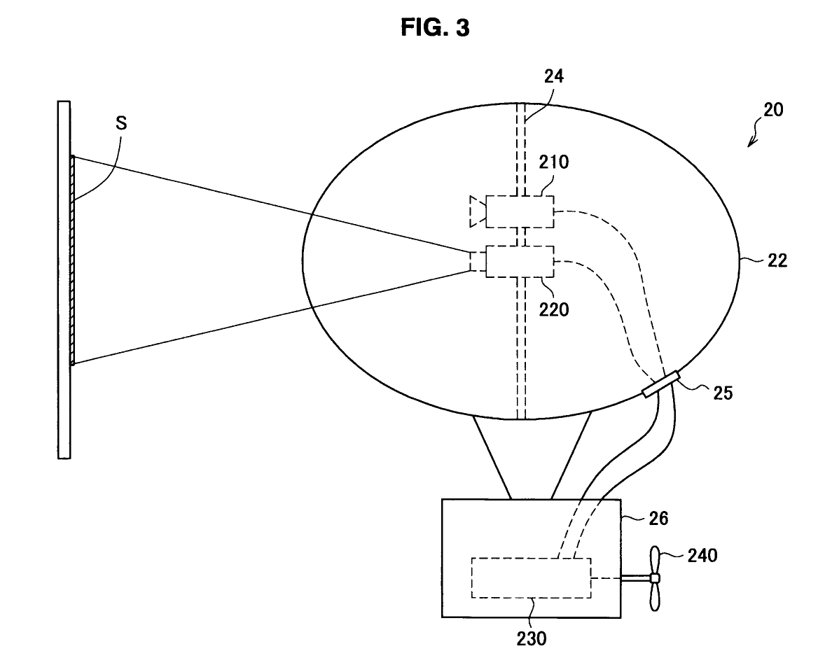

Further, the gondola unit 230 wirelessly receives an image from the external information processing device 10 and supplies the received image to the projecting unit 220. Then, the projecting unit 220 projects the image supplied from the gondola unit 230. The balloon 20 according to the first embodiment can switch display mode between first display mode that displays an image projected by the projecting unit 220 on the envelope 22 and second display mode that displays the image on an external object through the envelope 22. Hereinafter, the first display mode is described with reference to FIG. 2, and the second display mode is described with reference to FIG. 3.

FIG. 2 is an explanatory view showing the balloon 20 operating in the first display mode. As shown in FIG. 2, in the first display mode, an image S projected from the projecting unit 220 can be displayed on the surface of the envelope 22. The first display mode is implemented by projecting the image S on the half-transparent part of the envelope 22.

FIG. 3 is an explanatory view showing the balloon 20 operating in the second display mode. As shown in FIG. 3, in the second display mode, an image S projected from the projecting unit 220 can be displayed on various kinds of external objects, such as a wall, a floor, a screen or a ground. The second display mode is implemented by projecting the image S on the transparent part of the envelope 22.

A method of switching the display mode is described in detail later in “1-3. Method of Switching Display Mode”. Further, a specific example of an application that makes use of each display mode is described in detail later in “1-4. Application”.

### (Supplementary Explanation: Payload of Balloon)

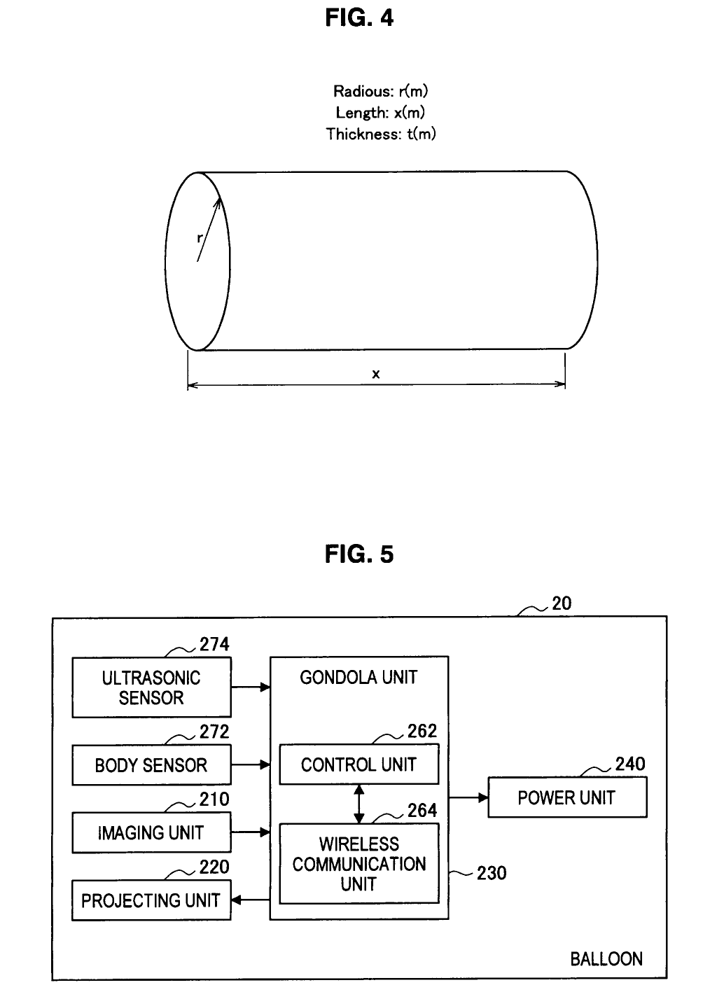

A payload of the balloon 20 is described hereinafter with reference to FIG. 4. First, a payload P of the balloon 20 is represented by the following equation 1. Note that, in the equation 1, Bp indicates the buoyancy of the balloon 20, and Wb indicates the weight of the balloon 20.

P=Bb−Wb Equation 1

When the ambient temperature is 20° C., the density of air in normal condition is 1.293 Kg/m³, and the density of gas (e.g. helium gas) filled in the envelope 22 is 0.1785 Kg/m³, buoyancy per 1 m³ is represented by the following equation 2. Accordingly, the buoyancy Bp of the balloon 20 is represented by the following equation 3. Further, the weight Wb of the balloon 20 is represented by the following equation 4. Note that By in the equation 3 indicates the volume in the envelope 22, Bs in the equation 4 indicates the surface area of the envelope 22, and ρ indicates the density of the material of the envelope 22.

Buoyancy=1.205−0.1664=1.040 Kg/m³ Equation 2

Bb=Bv×1.040 Equation 3

Wb=Bs×ρ Equation 4

Therefore, when it is assumed that the envelope 22 has a columnar shape shown in FIG. 4, the payload of the balloon 20 can be calculated as shown in the following equation 7, which is derived from the equation 5 and the equation 6. Note that, in the following equations, it is assumed that the envelope 22 is made of polyethylene, and the density of polyethylene is 940 Kg/m³.

Bp=πr²×x×1.040 Equation 5

Wb(Kg)=(2πr²+2πrx)×t×ρ=2πr(r+x)×t×p Equation 6

=1880πr(r+x)×t

P(Kg)=Bb−Wb=πr(rx−1880(r+x)×t) Equation 7

### 1-2. Structure of Balloon

The outline of the balloon 20 according to the first embodiment is described above with reference to FIGS. 1 to 4. The structure of the balloon 20 according to the first embodiment is described hereinbelow.

FIG. 5 is a functional block diagram showing the structure of the balloon 20 according to the first embodiment. Referring to FIG. 5, the balloon 20 according to the first embodiment includes an imaging unit 210, a projecting unit 220, a power unit 240, a gondola unit 230 including a control unit 262 and a wireless communication unit 264, a body sensor 272, and an ultrasonic sensor 274. The imaging unit 210, the projecting unit 220 and the power unit 240 are described earlier in “1-1. Outline of Balloon according to First Embodiment”, and detailed explanation is omitted below.

The control unit 262 controls the overall operation of the balloon 20, such as projection of an image by the projecting unit 220 and movement of the balloon 20 by the power unit 240. Further, the control unit 262 can switch the display mode of an image projected from the projecting unit 220 in various ways as described later in “1-3. Method of Switching Display Mode”.

The wireless communication unit 264 wirelessly communicates with the external information processing device 10. For example, the wireless communication unit 264 receives an image to be projected from the projecting unit 220, an operation instruction for the balloon 20 or the like from the external information processing device 10, and transmits an image captured by the imaging unit 210 to the external information processing device 10.

The body sensor 272 is a sensor that detects a human body existing in the vicinity. The body sensor 272 may detect a body position using infrared ray, sound, heat or the like.

The ultrasonic sensor 274 functions as a distance estimation unit that estimates the distance from an external object. The ultrasonic sensor 274 may estimate the distance between the balloon 20 and an external object based on a reflected wave of an emitted ultrasonic wave, for example.

### 1-3. Method of Switching Display Mode

A method for the balloon 20 according to the first embodiment to switch the display mode of an image projected from the projecting unit 220 is specifically described hereinbelow.

### (First Switching Method)

When the envelope 22 has a transparent region and a half-transparent region, the control unit 262 of the balloon 20 according to the first embodiment switches the display mode by controlling the projection direction of an image by the projecting unit 220.

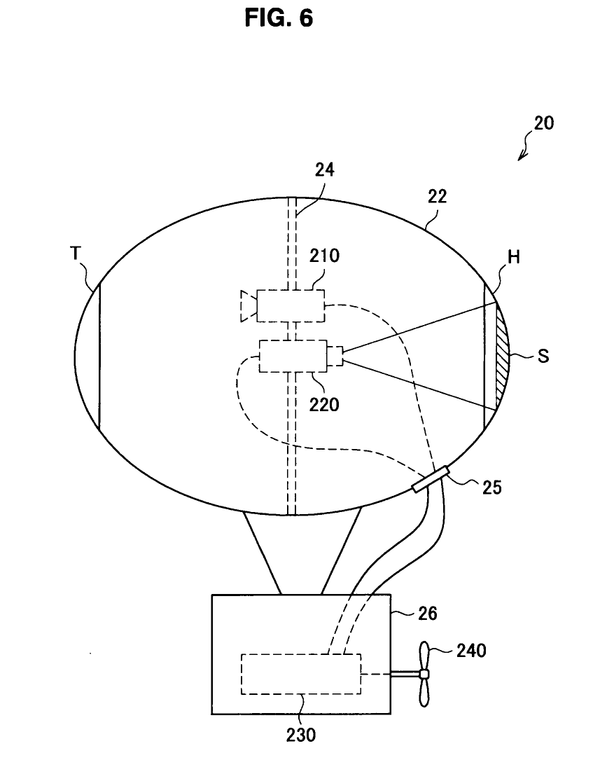

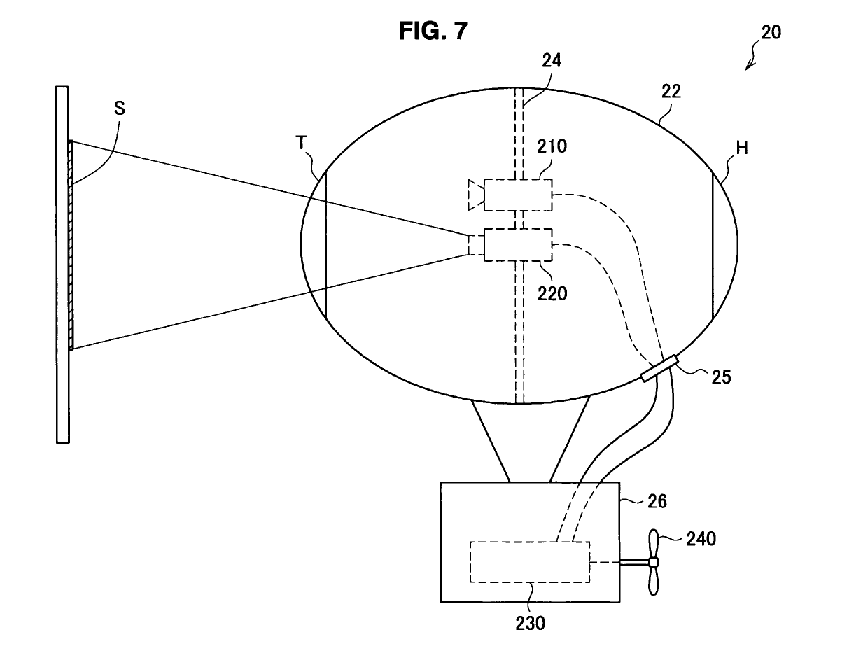

FIGS. 6 and 7 are explanatory views showing a method of switching display mode according to the first method. When the envelope 22 has a transparent region T and a half-transparent region H as shown in FIGS. 6 and 7, the control unit 262 can switch the display mode to the first display mode by turning the projection direction of an image by the projecting unit 220 toward the half-transparent region H as shown in FIG. 6. The image S projected from the projecting unit 220 can be thereby displayed on the half-transparent region H of the envelope 22.

On the other hand, the control unit 262 can switch the display mode to the second display mode by turning the projection direction of an image by the projecting unit 220 toward the transparent region T as shown in FIG. 7. The image S projected from the projecting unit 220 can be thereby displayed on an external object.

Note that the control unit 262 may control the projection direction of the projecting unit 220 by rotating a connection part (not shown) between the projecting unit 220 and the stationary member 24, for example. Further, the control unit 262 may invert the left and right of an image projected from the projecting unit 220 between the first display mode and the second display mode.

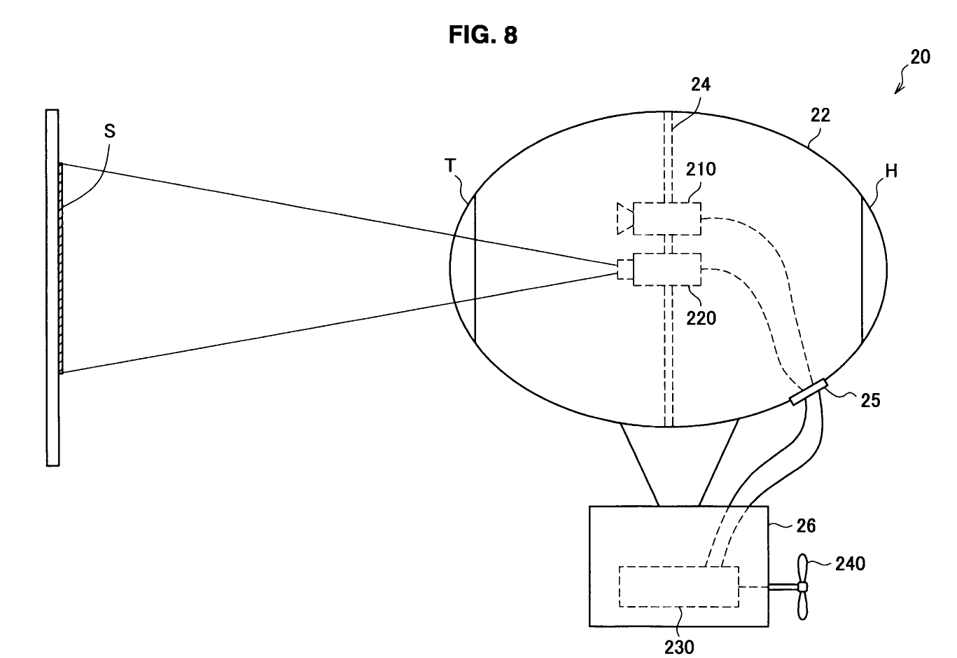

Further, when the balloon 20 is operating in the second display mode, the display size of the image S projected from the projecting unit 220 on an external object depends on the distance between the balloon 20 and the external object. Thus, the control unit 262 may control the zoom of the image projected from the projecting unit 220 depending on the distance between the balloon 20 and the external object which is estimated by the ultrasonic sensor 274 as shown in FIG. 8.

FIG. 8 is an explanatory view showing a specific example of controlling the zoom of an image depending on the distance between the balloon 20 and an external object. The control unit 262 can display the image S with a constant size regardless of the distance between the balloon 20 and the external object by reducing the zoom level of the image S projected from the projecting unit 220 as the distance between the balloon 20 and the external object is longer as shown in FIG. 8, for example.

Further, when the balloon 20 is operating in the second display mode, it is preferred that a user who views an image projected on an external object is present near the image. Thus, the control unit 262 may move the power unit 240 so that the balloon 20 gets closer to the body position detected by the body sensor 272 and also makes the balloon 20 operate in the second display mode. In this structure, the image projected from the projecting unit 220 can be displayed near the body position detected by the body sensor 272.

### (Second Switching Method)

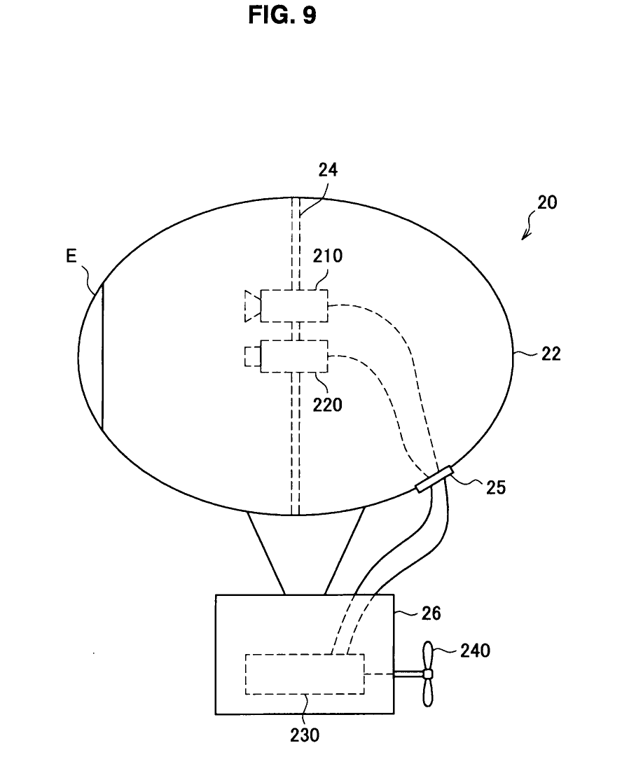

A second method for the balloon 20 to switch the display mode is described hereinafter with reference to FIG. 9.

FIG. 9 is an explanatory view showing the structure of the balloon 20 for switching the display mode according to the second method. As shown in FIG. 9, the envelope 22 has a variable region E where transparency varies depending on an applied voltage. Therefore, the control unit 262 can switch the display mode of an image projected from the projecting unit 220 by controlling an applied voltage to the variable region E.

Specifically, the control unit 262 can switch the display mode to the first display mode by controlling an applied voltage to the variable region E so that the variable region E turns into the half-transparent state. The image S projected from the projecting unit 220 can be thereby displayed on the variable region E of the envelope 22.

On the other hand, the control unit 262 can switch the display mode to the second display mode by controlling an applied voltage to the variable region E so that the variable region E turns into the transparent state. The image S projected from the projecting unit 220 can thereby pass through the variable region E of the envelope 22 and be displayed on an external object.

### (Third Switching Method)

Although the example in which the envelope 22 has the variable region E where transparency varies depending on an applied voltage from the control unit 262 is described in the second method, the envelope 22 may have a material part where transparency varies depending on the external environment. For example, the material part may be made of a material that changes from the transparent state to the half-transparent state by exposure to sunlight, or may be made of a material with transparency varying depending on the external temperature or the external humidity.

In this structure, the display mode is switched to the first display mode when the material part turns into the half-transparent state, and the display mode is switched to the second display mode when the material part turns into the transparent state.

### 1-4. Application

Specific methods for switching the display mode of the balloon 20 are described above. Hereinafter, an example of an application that uses the display mode of the balloon 20 is described.

### First Example

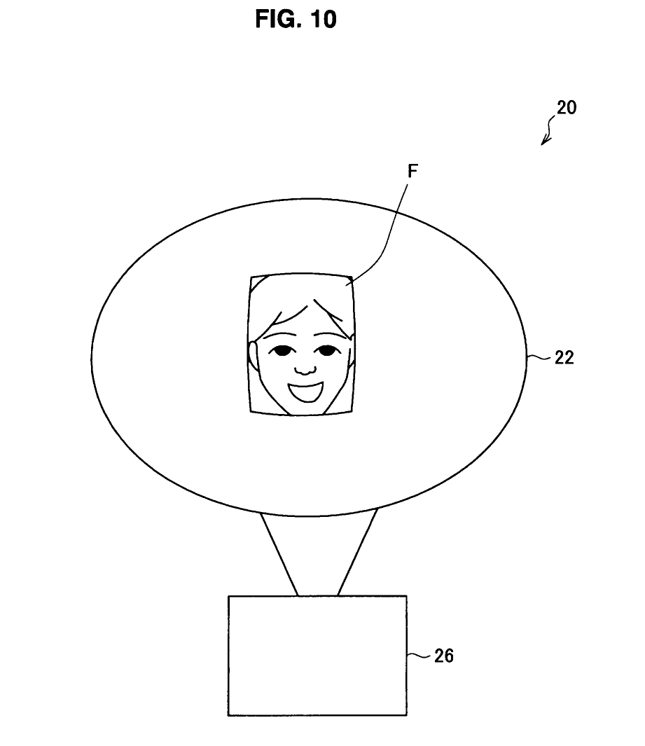

As a first example of the application, an application that uses the balloon 20 as an avatar as shown in FIG. 10 is described below.

FIG. 10 is an explanatory view showing an application that uses the balloon 20 as an avatar. As shown in FIG. 10, a face image F is displayed on the envelope 22 of the balloon 20, so that the balloon 20 can be used as an avatar. For example, the control unit 262 makes the balloon 20 operate in the first display mode and the projecting unit 220 projects a face image toward the envelope 22, thereby displaying the face image on the envelope 22.

The face image projected by the projecting unit 220 may be a face image of a user which is captured in real time and received by the wireless communication unit 264. In this structure, when a plurality of balloons 20 get together, a plurality of users can make visual communication through the balloons 20 by capturing a face image of another user displayed on another balloon using the imaging unit 210 of each balloon. Further, in order to make auditory communication, an output unit and a sound collecting unit of a user voice may be mounted on the balloon 20.

Further, a mask imitating a person or a cartoon character may be attached to the display position of the face image F projected from the projecting unit 220. For example, if a mask of a user is attached to the display position of the face image F projected from the projecting unit 220, the face image F can be displayed more clearly. Further, when attaching a mask imitating a cartoon character to the display position, the projecting unit 220 may selectively project a part of the user's face image which corresponds to a mask space (e.g. an eye part, a mouth part etc.).

### Second Example

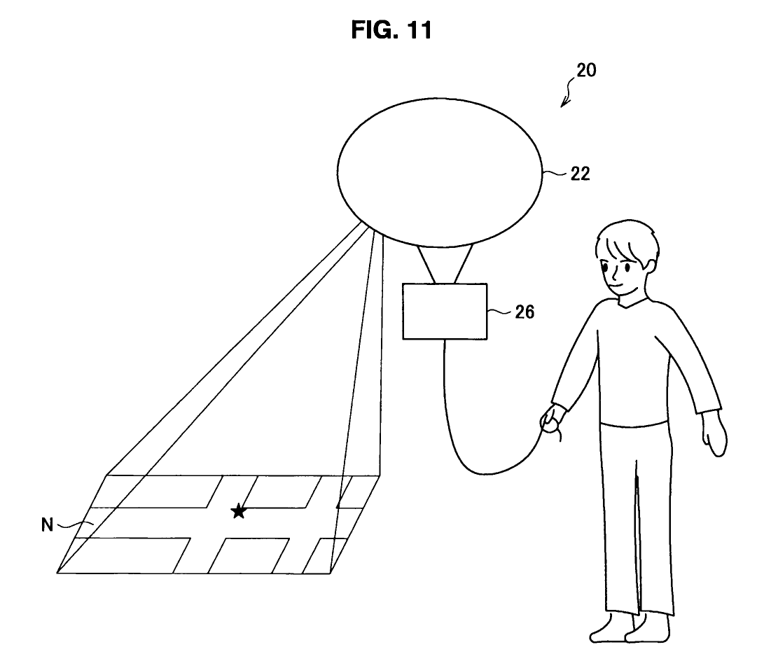

As a second example of the application, an application that uses the balloon 20 as a navigation device as shown in FIG. 11 is described below.

FIG. 11 is an explanatory view showing an application that uses the balloon 20 as a navigation device. As shown in FIG. 11, the control unit 262 makes the balloon 20 operate in the second display mode and the projecting unit 220 projects a navigation image N toward the opposite direction (downward direction) to the floating direction of the balloon 20, so that the navigation image N can be displayed on the ground, for example.

Note that, in order to project the navigation image N, the balloon 20 may include a storage unit that stores map information, a position information acquisition unit (e.g. a GPS receiver), and a navigation screen generation unit that superposes current position information on the map information.

As described above, according to the second example of the application, it is possible to assist a user in moving by displaying the navigation image N on the ground, for example.

### Third Example

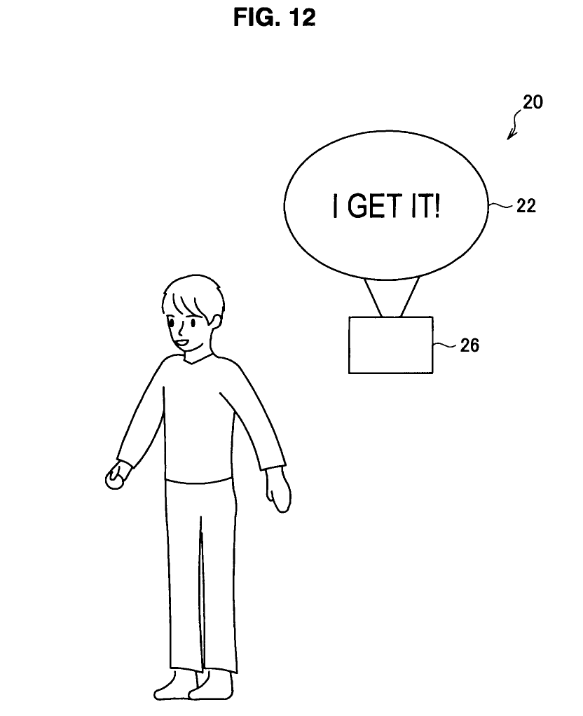

As a third example of the application, an application that uses the balloon 20 as a “speech balloon” as shown in FIG. 12 is described below. The “speech balloon” is commonly used in comic books to represent the speech of a given character in the comic. However, in this application, the “speech balloon” of a user is represented by the balloon 20 in the real world.

FIG. 12 is an explanatory view showing an application that uses the balloon 20 as the speech balloon. As shown in FIG. 12, the control unit 262 makes the balloon 20 operate in the first display mode and the projecting unit 220 projects a text image “I get it!”, so that the envelope 22 can be used as the speech balloon.

Note that the text image may be supplied to the projecting unit 220 in various ways. For example, a speech recognition function may be incorporated into the balloon 20, and the speech recognition function may recognize a speech spoken by a user and supply a text image corresponding to the recognized speech to the projecting unit 220. Alternatively, a user may input a text to the information processing device 10, and the information processing device 10 may transmit an image of the input text to the balloon 20.

### 1-5. Operation of Balloon

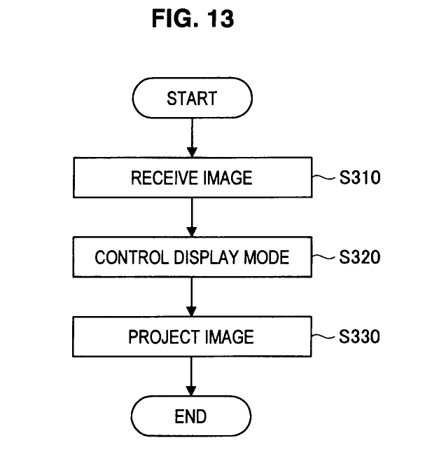

Specific examples of the application that makes use of the balloon 20 according to the embodiment of the present invention are described above. Hereinafter, the operation of the balloon 20 according to the embodiment of the present invention is briefly described with reference to FIG. 13.

FIG. 13 is a flowchart showing the operation of the balloon 20 according to the first embodiment of the present invention. As shown in FIG. 13, the wireless communication unit 264 of the balloon 20 first receives an image from the external information processing device 10 (S310). Then, the control unit 262 controls the display mode of the balloon 20 (S320).

In this step, the control unit 262 may control the display mode based on an instruction explicitly indicating the first display mode or the second display mode from the external information processing device 10 or may control the display mode based on an implicit instruction. For example, the control unit 262 may treat an image type received by the wireless communication unit 264 as an implicit instruction for the display mode and control the display mode depending on the image type. Specifically, when an image received by the wireless communication unit 264 is a face image, the control unit 262 may switch the display mode to the first display mode. The application that uses the balloon 20 as an avatar, as described as the first example of the application, can be thereby executed. Note that the balloon 20 may include an operating unit for a user to directly indicate the display mode to the balloon 20.

After that, the projecting unit 220 projects an image received by the wireless communication unit 264 (S330).

As described above, according to the first embodiment of the present invention, the display mode can be switched between the first display mode that displays an image projected from the projecting unit 220 on the envelope 22 and the second display mode that displays the image on an external object through the envelope 22. This structure allows use of one balloon 20 for various applications.

### 2. Second Embodiment

The first embodiment is described above. The second embodiment of the present invention is described hereinbelow.

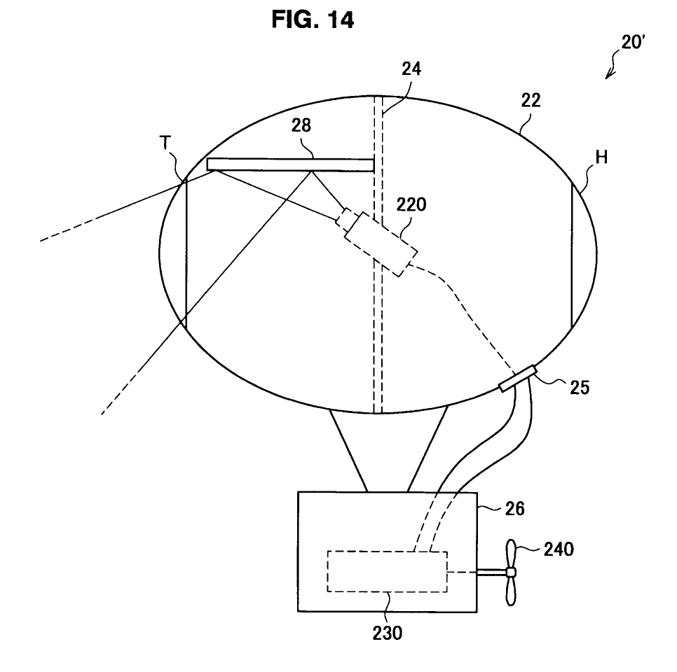

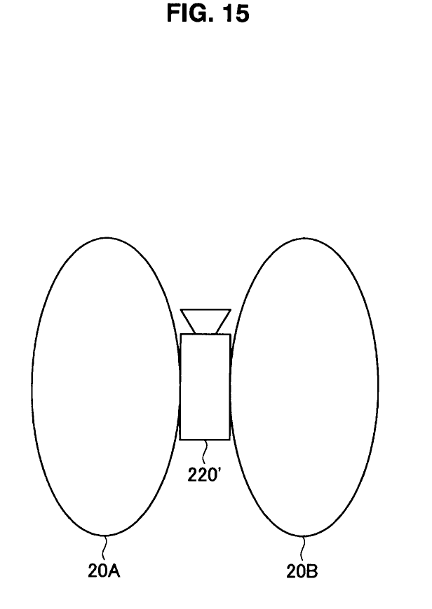

FIG. 14 is an explanatory view showing a structure of a balloon 20′ according to the second embodiment of the present invention. As shown in FIG. 14, the balloon 20′ according to the second embodiment includes an envelope 22, a connector 25, and a gondola 26. Further, a stationary member 24, a projecting unit 220 coupled to the stationary member 24, and a reflector 28 are mounted inside the envelope 22. Furthermore, the gondola 26 incorporates a gondola unit 230 and has a power unit 240 mounted outside.

The reflector 28 reflects an image projected from the projecting unit 220. Thus, when the balloon 20′ operates in the second display mode as shown in FIG. 14, the image reflected by the reflector 28 passes through the transparent region T and is displayed on an external object.

When the image is not reflected on the reflector 28, the display size of the image on the external object is restricted depending on the distance between the projecting unit 220 and the external object. On the other hand, in the second embodiment, the projection path length of the image can be elongated by reflecting the image on the reflector 28, and it is thereby possible to enlarge the display size of the image on the external object.

Note that the control unit 262 can make the balloon 20 operate in the second display mode by turning the reflecting direction of the image by the reflector 28 toward the transparent region T as shown in FIG. 14. On the other hand, the control unit 262 can make the balloon 20 operate in the first display mode by turning the reflecting direction of the image by the reflector 28 toward the half-transparent region H.

In the first display mode as well, the display size of an image on the half-transparent region H can be enlarged. Specifically, when an image is not reflected on the reflector 28 in the first display mode, the display size of the image on the half-transparent region H is restricted depending on the distance between the projecting unit 220 and the half-transparent region H. On the other hand, in the second embodiment, the projection path length of the image can be elongated by reflecting the image on the reflector 28, and it is thereby possible to enlarge the display size of the image on the half-transparent region H.

### 3. Summary

As described above, the balloon 20 according to the embodiment of the present invention can switch the display mode between the first display mode that displays an image projected from the projecting unit 220 on the envelope 22 and the second display mode that displays the image on an external object through the envelope 22. This structure allows use of one balloon 20 for various applications.

Further, the balloon 20′ according to the second embodiment of the present invention reflects an image projected from the projecting unit 220 by the reflector 28 inside the envelope 22. This structure elongates the projection path length of the image and thus allows an increase in the display size of the image both in the first display mode and the second display mode.

Although preferred embodiments of the present invention are described in detail above with reference to the appended drawings, the present invention is not limited thereto. It should be understood by those skilled in the art that various modifications, combinations, sub-combinations and alterations may occur depending on design requirements and other factors insofar as they are within the scope of the appended claims or the equivalents thereof.

For example, although the example in which the projecting unit 220 is placed inside the balloon 20 is described in the above embodiment, the present invention is not limited thereto. An alternative example is described hereinafter with reference to FIG. 15.

FIG. 15 is an explanatory view showing an alternative example of the embodiment of the present invention. As shown in FIG. 15, a projecting unit 220′ may be placed between a plurality of balloons 20A and 20B. In this structure, because the projecting unit 220′ is exposed, maintenance or adjustment of the projecting unit 220′ can be performed easily. Further, although only two balloons 20A and 20B are illustrated in FIG. 15, flexibility for the overall shape or buoyancy can be improved by combining a larger number of balloons 20. For example, by combining balloons 20 respectively corresponding to a head, a body, a right hand, a left hand, a right leg and a left leg, the overall shape of a human can be obtained.

Further, it is not always necessary to perform the steps in the processing of the balloon 20 of the specification in chronological order according to the sequence shown in the flowcharts. For example, the steps in the processing of the balloon 20 may be processed in a difference sequence from the sequence shown in the flowcharts or may be processed in parallel.

Furthermore, it is possible to create a computer program that causes hardware such as a CPU, ROM and RAM incorporated in the balloon 20 to perform the equal functions to the elements of the balloon 20 described above. Further, a storage medium that stores such a computer program may be provided. Furthermore, each functional block shown in the functional block diagram of FIG. 5 may be implemented by hardware, thereby achieving a series of processing on hardware.

The present application contains subject matter related to that disclosed in Japanese Priority Patent Application JP 2010-119135 filed in the Japan Patent Office on May 25, 2010, the entire content of which is hereby incorporated by reference.

What is claimed is:

1. A balloon comprising:
an envelope; and
a projecting unit that projects an image,
wherein display mode is switched between first display mode that displays the image projected by the projecting unit on the envelope and second display mode that displays the image projected by the projecting unit on an external object through the envelope.

2. The balloon according to claim 1, wherein
the envelope includes a transparent region and a half-transparent region having lower transparency than the transparent region, and
the balloon further includes a control unit that switches the display mode to the first display mode by turning a projecting direction of the image by the projecting unit toward the half-transparent region, and switches the display mode to the second display mode by turning a projecting direction of the image by the projecting unit toward the transparent region.

3. The balloon according to claim 1, further comprising:
a reflector that reflects the image projected by the projecting unit to display the image on the envelope or the external object.

4. The balloon according to claim 3, wherein
the envelope includes a transparent region and a half-transparent region having lower transparency than the transparent region, and
the balloon further includes a control unit that switches the display mode to the first display mode by making the reflector reflect the image projected by the projecting unit toward the half-transparent region, and switches the display mode to the second display mode by making the reflector reflect the image projected by the projecting unit toward the transparent region.

5. The balloon according to claim 1, wherein
the envelope includes a variable region where transparency varies depending on an applied voltage, and
the balloon further includes a control unit that switches the display mode between the first display mode and the second display mode by controlling an applied voltage to the variable region.

6. The balloon according to claim 1, wherein
the envelope includes a material part where transparency varies depending on an external environment, and
the display mode is switched between the first display mode and the second display mode in response to variation of the transparency of the material part depending on the external environment.

7. The balloon according to claim 2, wherein
the projecting unit projects a face image, and
the control unit makes the balloon operate in the first display mode when the face image is projected by the projecting unit.

8. The balloon according to claim 7, wherein
a mask is attachable to the envelope in a display position of the face image projected from the projecting unit.

9. The balloon according to one of claim 2, comprising:
a sensor that detects a body position; and
a power unit that moves the balloon to approach the body position detected by the sensor,
wherein the control unit makes the balloon operate in the second display mode when the balloon is moved by the power unit to approach the body position detected by the sensor.

10. The balloon according to claim 2, wherein
the projecting unit projects a navigation image in an opposite direction to a floating direction of the balloon, and
the control unit makes the balloon operate in the second display mode when the navigation image is projected by the projecting unit.

11. The balloon according to claim 2, wherein
the projecting unit projects a text image, and
the control unit makes the balloon operate in the first display mode when the text image is projected by the projecting unit.

12. The balloon according to claim 2, further comprising:
a wireless communication unit that wirelessly communicates with an external device,
wherein the control unit controls the display mode according to an instruction received by the wireless communication unit.

13. The balloon according to claim 1, further comprising:
a wireless communication unit that wirelessly communicates with an external device,
wherein the projecting unit projects an image received by the wireless communication unit.

14. The balloon according to claim 13, further comprising:
an imaging unit that captures an image,
wherein the wireless communication unit transmits the image captured by the imaging unit to the external device.

15. The balloon according to one of claim 1, further comprising:
a distance estimation unit that estimates a distance from the external object,
wherein the control unit controls zoom of the image projected from the projecting unit depending on the distance estimated by the distance estimation unit when the balloon operates in the second display mode.

16. A balloon control method comprising steps of:
projecting an image toward an envelope; and
switching display mode between first display mode that displays the projected image on the envelope and second display mode that displays the projected image on an external object through the envelope.
